(19) United States
(12) Patent Application Publication
(10) Pub. No.: US 2013/0346263 A1
(43) Pub. Date: Dec. 26, 2013

(54) FUNDRAISING SYSTEMS, METHODS AND APPARATUS

(71) Applicant: THE LEUKEMIA & LYMPHOMA SOCIETY, White Plains, NY (US)

(72) Inventors: Jeff Como, White Plains, NY (US); John Walter, Scarsdale, NY (US)

(73) Assignee: THE LEUKEMIA & LYMPHOMA SOCIETY, White Plains, NY (US)

(21) Appl. No.: 13/791,646

(22) Filed: Mar. 8, 2013

Related U.S. Application Data
(60) Provisional application No. 61/663,807, filed on Jun. 25, 2012.

(51) Int. Cl. G06Q 30/02

(52) U.S. Cl. CPC G06Q 30/0279
USPC 705/30

(57) ABSTRACT

A method is provided to associate an independent entity that collects financial instruments on behalf of an organization with funds collected on behalf of the organization. A system is also provided for associating an independent entity that collects financial instruments on behalf of an organization with funds collected on behalf of the organization. An apparatus may also be provided for associating an independent entity that collects financial instruments on behalf of an organization with funds collected on behalf of the organization.

### FIELD OF THE INVENTION

This invention relates to an interactive method, system and apparatus for processing third-party financial instruments that identify an amount of funds payable to an organization by a contributing third party entity.

### BACKGROUND

In both profit and not-for-profit business models, revenue may be generated through an indirect and independent sales or distributor model. In this business model, entities that are not directly employed by an organization (hereinafter “independent entities” or “participants”) collect monies (e.g., by selling, fundraising and the like) on behalf of the organization in exchange for goods and/or services. In the case of non-profits, participants raise funds for a charitable cause by soliciting donations from individual, corporate and group third-party entities (hereinafter “third party entities” or “donors”). In some instances, non-profit organizations recognize fundraising amounts achieved by individual participants by notifying the participants and/or donors when pre-established fundraising goals have been achieved (with such goals often being attributable to a single event or over an extended period of time).

This multi-level marketing model generally engages three main actors in the solicitation and exchange of funds on behalf of an organization:
The organization (“payee”) that will benefit from revenue raised on its behalf (including both for-profit and not-for-profit organizations).
The independent entity (“participant”) that is the collection agent for all funds. This entity can be an independent agent, distributor or, in the case of non-profits, a fundraising entity that is acting as a voluntary agent to help raise funds for a charitable cause. This entity solicits and collects funds on behalf of the organization and may receive “credit” for efforts in generating those funds from the organization.
The third party entity (“donor” or “payor”) that is purchasing or donating to the organization through an independent entity. This is the actor who generates the originating funds and may be an individual, a group or an institution (e.g., a company having matching funds).

Organizations face inherent problems in the processing of third party financial instruments collected by independent entities that solicit these payments on behalf of one or more designated organizations. In addition to lacking any immediate means for collecting funds designated by such financial instruments, organizations must incur the cost of collecting, depositing and clearing each financial instrument to the detriment of the organization's bottom line. In addition, it is difficult to reconcile cleared transactions with the donors who contributed funds and provide appropriate recognition (e.g., an acknowledgement of appreciation, a receipt for tax purposes or an invitation to donate to or participate in future campaigns). Additional difficulty is introduced by the need to further reconcile the cleared transactions with the participant's fundraising totals and recognize the participant for his/her role in meeting the organization's fundraising or sales goals. If checks are mishandled or go “NSF”, for example, the organization will reduce the credit the participant receives. Other deficiencies in existing systems relate to the inability to collect financial instruments or checks from many different people (e.g., a rush of people who want to hand in their checks at the beginning or near the start of an event). Other problems relate to being able to provide real time receipt confirmation and acknowledgement of contributions as they are processed by a participant. Other issues can relate to proper attribution of checks or other financial instruments and the integration of data capture, check collection, customer relations management, and managing current and future drives.

The presently disclosed invention now provides such solutions and provides other advantages that are understood from the present disclosure.

### SUMMARY

In accordance with the principles of the present inventions, systems, method, and computer readable medium can be implemented to improve existing financial and relationship tools for participants, third party entities, and organizations. For example, a method is provided for associating at least one of an independent entity or a third party with funds collected by the independent entity on behalf of an organization. Such funds may be designated by one or more financial instruments collected from one or more third parties. Association of the funds with each independent entity and third party facilitates immediate acknowledgment of the receipt of the funds by the organization commensurate with any fundraising goals established by the organization.

A method for operating an automated programmed computer system is provided to associate an independent entity that collects financial instruments on behalf of an organization with funds collected on behalf of the organization. The method includes capturing an image of each financial instrument collected from a plurality of third party entities using a financial contribution management application in operative communication with an image capture component of a network-connected client device. Each financial instrument can for example identify an amount of funds, the organization as a payee, and a contributing third party entity. The captured image of each financial instrument is sent to a destination to apply the captured image to a payment processor for the organization to deposit and clear the instrument for the organization. A communications message, notifying the independent entity of a successful deposit of funds from one or more financial instruments, is generated in response to sending the captured images. Also in response to sending the captured image, each amount of funds from the image-captured financial instruments is recorded in a database as a recognized monetary contribution raised by the independent entity and given by the third-party entity to the organization. The recognized monetary contribution is added to a fundraising total associated with the independent entity. The independent entity is provided with an option to view the fundraising total from third party entities for the organization. The network-connected client device may effect at least one of the image capturing and sending.

The method can further include providing a platform comprising a network interface that enables performance of actions including at least one of communicating over a network; facilitating registration of the independent entity with the organization; and accessing the platform by the registered independent entity. The platform further comprises a third-party data acquisition database that stores third-party data acquired from the captured image and an engine. An engine is also provided that is configured to at least associate amounts of funds from financial instruments with the third-party data; record deposited funds as recognized monetary contributions associated with at least one of the independent entity and third-party entity; update the fundraising total; and associate the updated fundraising total with the independent entity.

The method may further include recognizing at least one of the independent entity for collecting funds on behalf of the organization and the third-party entity for generating funds on behalf of the organization. The recognizing includes generating a notification that notifies the independent entity with updated fundraising totals and credits at least one of the independent entity and the third-party entity to an extent commensurate with at least one of the recognized monetary contribution and the associated fundraising total. Generation of the notification may be based upon matches between an independent entity's fundraising total and at least one of target monetary contributions and target fundraising totals. The notification can include at least one of a current fundraising total, an acknowledgment of appreciation and a receipt for the recognized monetary contribution.

The method can additionally include recording third-party data acquired from the captured image into a database associated with the organization. Registering the independent entity with the organization allows the organization to uniquely identify each independent entity that will be fundraising on its behalf.

An integrated financial instrument management system is also provided for associating an independent entity that collects financial instruments on behalf of an organization with funds collected on behalf of the organization. The system includes a server in communication with a search engine and at least one network-connected client device having an image capture component in operative communication with a financial contribution management application.

An apparatus is also provided for associating an independent entity that collects financial instruments on behalf of an organization with funds collected on behalf of the organization. The apparatus includes a network interface for communicating over a network and a computer-readable medium. The computer-readable medium is configured to perform actions that include accessing an integrated financial instrument management system over the network and capturing an image of each financial instrument collected from a plurality of third party entities using a financial contribution management application in operative communication with an image capture component of a network-connected client device. The computer readable medium can include one medium or plural media such as separate structures. Any software that carries out the steps and functions described herein can be stored on a non-transitory medium. Computer-readable instructions that may be recorded on a non-transitory medium can, when executed, perform one or more steps of the functions described herein without any deference to sequence.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 shows an example of a computing environment in which embodiments of the presently disclosed system and process may be implemented.

FIG. 2 shows an shows an exemplary process for processing third-party financial instruments in an integrated financial instrument management system via a network interface.

FIG. 3 shows an exemplary login page presented by a network interface.

FIG. 4 shows an exemplary financial contribution management application provided by the integrated financial instrument management system via a network-connected mobile device.

FIG. 5 shows an exemplary third-party financial instrument processed by the integrated financial instrument management system.

FIGS. 6 and 7 show exemplary notifications generated by the integrated financial instrument management system on a mobile device display.

### DETAILED DESCRIPTION

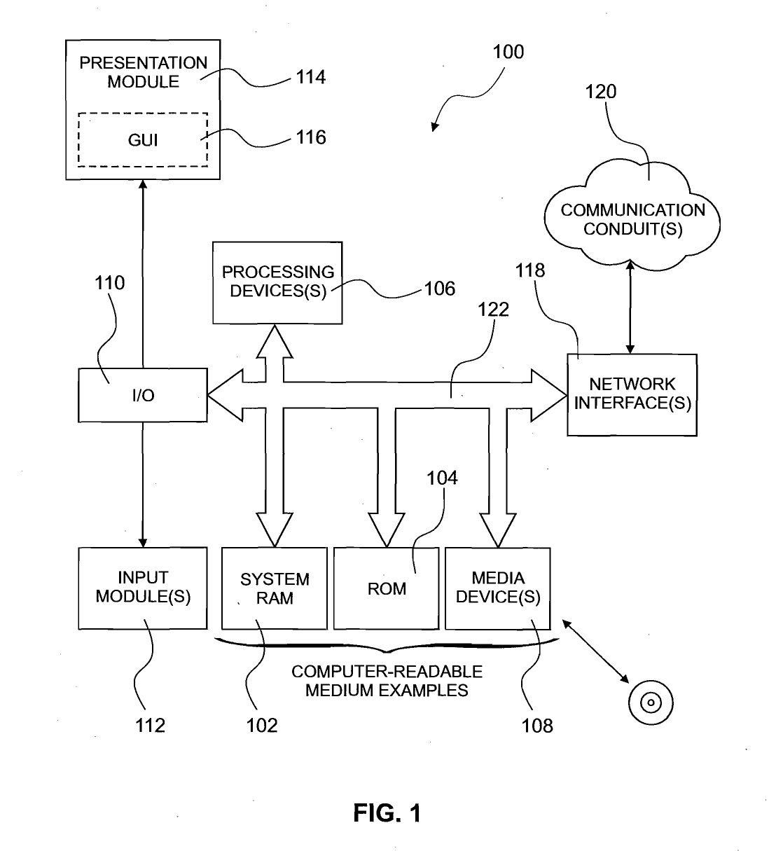

Now referring to the figures, wherein like numbers represent like elements, an integrated third party financial instrument management method and system as described herein may be implemented in connection with a mobile networking apparatus that includes hardware, software, or, where appropriate, a combination of both. FIG. 1 sets forth illustrative electrical data processing functionality 100 that can be used to implement aspect of the functions described herein. In one case, the processing functionality 100 may correspond to a computing device that includes one or more processing devices. The computing device can include a computer, computer system or other programmable electronic device, including a client computer, a server computer, a portable computer (including a laptop and a tablet), a handheld computer, a mobile phone (including a smart phone), a gaming device, an embedded controller and any combination and/or equivalent thereof (including touchless devices). Moreover, the computing device may be implemented using one or more networked computers, e.g., in a cluster or other distributed computing system. It is understood that the exemplary environment illustrated in FIG. 1 is not intended to limit the present disclosure, and that other alternative hardware and/or software environments may be used without departing from the scope of this disclosure.

For clarity, as used herein, the term “server” includes one or more servers. A server can include one or more computers that manage access to a centralized resource or service in a network. A server can also include at least one program that manages resources (for example, on a multiprocessing operating system where a single computer can execute several programs at once). Further, the terms “computing device”, “computer device”, “computer” and “machine” are understood to be interchangeable terms and shall be taken to include any collection of computing devices that individually or jointly execute a set (or multiple sets) of instructions to perform any one or more of the methods discussed herein.

The processing functionality 100 can include volatile memory (such as RAM 102) and/or non-volatile memory (such as ROM 104 as well as any supplemental levels of memory, including but not limited to cache memories, programmable or flash memories and read-only memories). The processing functionality can also include one or more processing devices 106 (e.g, one or more central processing units (CPUs), one or more graphics processing units (GPUs), one or more microprocessors (μP) and similar and complementary devices) and optional media devices 108 (e.g., a hard disk module, an optical disk module, etc.).

The processing functionality 100 can perform various operations identified above with the processing device(s) 106 executing instructions that are maintained by memory (e.g., RAM 102, ROM 104 or elsewhere). The disclosed method and system may also be practiced via communications embodied in the form of program code that is transmitted over some transmission medium, such as over electrical wiring or cabling, through fiber optics, wirelessly or via any other form of transmission, wherein, when the program code is received and loaded into and executed by a machine, such as an EPROM, a gate array, a programmable logic device (PLD), a client computer, or the like, the machine becomes an apparatus for practicing the presently disclosed system and method. When implemented on a general-purpose processor, the program code combines with the processor to provide a unique apparatus that operates to invoke the functionality of the presently disclosed system and method. Additionally, any storage techniques used in connection with the presently disclosed method and/or system may invariably be a combination of hardware and software.

The processing functionality 100 also includes an input/output module 110 for receiving various inputs from a user (via input modules 112) and for providing various outputs to the user. One particular output mechanism may include a presentation module 114 and an associated graphical user interface (GUI) 116 incorporating one or more I/O devices (including but not limited to a display, a keyboard/keypad, a mouse and/or other pointing device, a trackball, a joystick, a haptic feedback device, a motion feedback device, a voice recognition device, a microphone, a speaker, a touch screen, a touchpad, a webcam, 2-D and 3-D cameras, and similar and complementary devices that enable operative response to user commands that are received at a computing device).

Otherwise, user input may be received via a computing device coupled to another computing device over a network. The processing functionality 100 can also include one or more network interfaces 118 for exchanging data with other devices via one or more communication conduits 120. One or more communication buses 122 communicatively couple the above-described components together. Bus 122 may represent one or more bus structures and types, including but not limited to a memory bus or memory controller, a peripheral bus, a serial bus, an accelerated graphics port, a processor or local bus using any of a variety of bus architectures and similar and complementary devices. This configuration may be desirable where a computing device is implemented as a server or other form of multi-user computer, although such computing device may also be implemented as a standalone workstation, desktop, or other single-user computer in some embodiments. In such configuration, the computing device desirably includes a network interface in operative communication with at least one network. The network may be a LAN, a WAN, a SAN, a wireless network, a cellular network, radio links, optical links and/or the Internet, although the network is not limited to these network selections. It will be apparent to those skilled in the art that storage devices utilized to provide computer-readable and computer-executable instructions and data can be distributed over a network.

The computing device can operate under the control of an operating system that executes or otherwise relies upon various computer software applications. For example, a database management system (DBMS) may be resident in the memory to access one or more databases (not shown). The databases may be stored in a separate structure, such as a database server, connected, either directly or through a communication link, with the remainder of the computing device. Moreover, various applications may also execute on one or more processors in another computer coupled to the computing device via a network in a distributed or client-server computing environment.

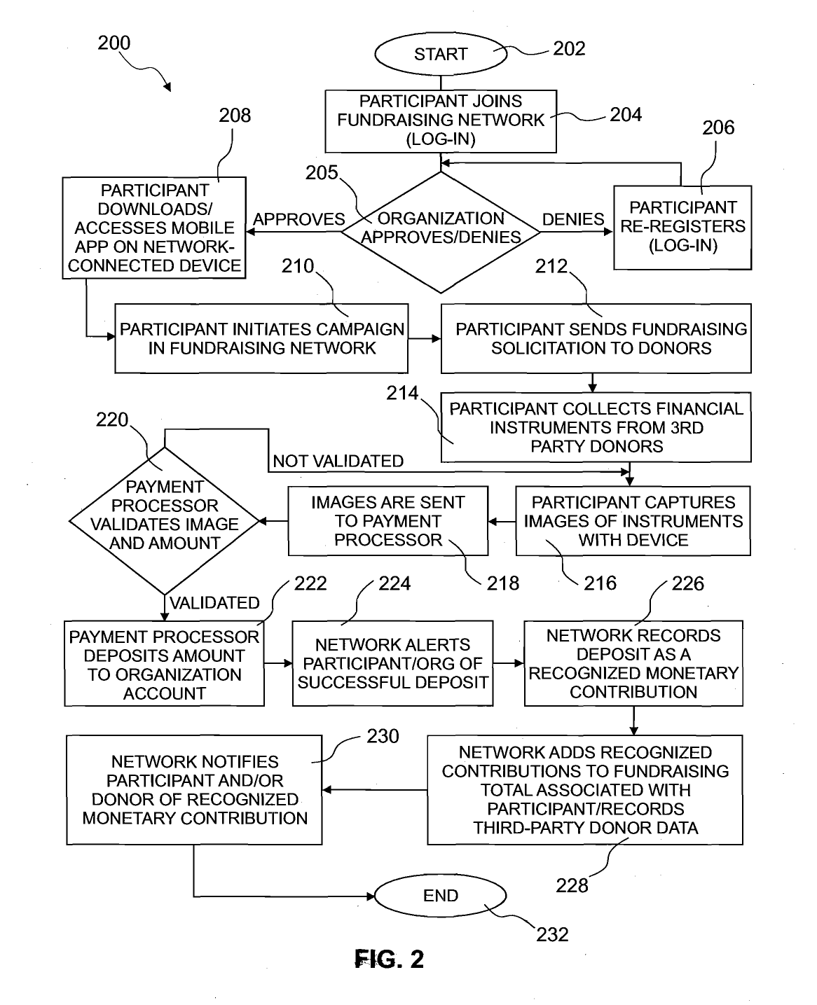

With reference now to FIG. 2, a user can initiate an integrated third party financial instrument management method by initiating process 200 for soliciting and collecting funds from third-party donors and processing collected funds when they are transferred by financial instruments such as checks. As used herein, a “user” may be a single user or a group of users and may include independent entities or participants, third party entities or donors, for-profit or non-profit organizations and any other individual, group or organization that might take part in generating revenue for the benefit of an organization. As used herein, the term “user” (or “user device”, “client device”, “network-connected device” or “device”) can refer to any electronic apparatus configured for receiving control input and configured to send commands or data either interactively or automatically to other devices. A user device can be an instance of an online user interface hosted on servers as retrieved by a user. As used herein, the term “process” or “method” refers to one or more steps performed at least by one electronic or computer-based apparatus. Steps may be performed in other ordering than shown without departing from the scope of the invention. Also, some steps may be optional and may be omitted.

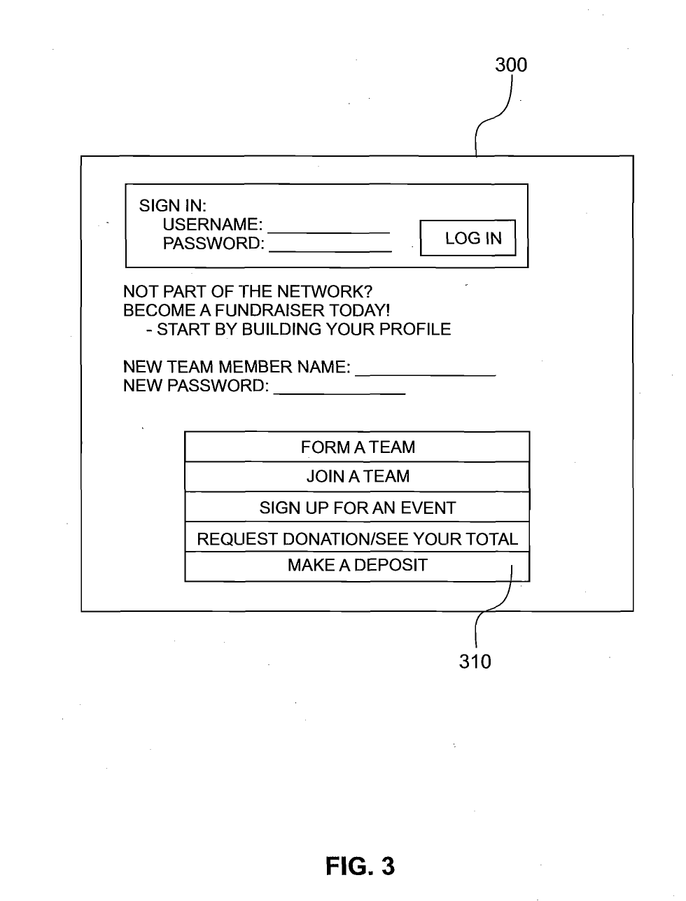

A process 200 starts at Step 202 when a user accesses an integrated financial instrument management system. Access may be granted via a network interface that presents a login page for the integrated financial instrument management system. An exemplary login page 300 is shown in FIG. 3, although login page 300 may have a variety of appearances and applications as understood by a person of ordinary skill in the art. In some embodiments, a log-in may not be immediately presented but may be accessible from another web page or from a mobile application.

At Step 204, the user may submit login credentials via login page 300, although in alternative embodiments, Step 204 may performed by software, such as a script that enters the login credentials when the login page is presented. At Step 204, a decision process 205 may be implemented for verifying the login credentials, such as looking up a username and password in a user database. If the login credentials are invalid, the organization may direct the user to Step 206, at which step login page 300 may be re-presented or the session may be terminated. If the login credentials are validated, access to various features of the integrated financial instrument management system is granted.

Also at Step 204, a user may register with the integrated financial instrument management system if the user is not already established as a “participant” or other recognized “member” of the community that can access the integrated financial instrument management system (see sample “New Team Member Name” and “New Password” configuration of FIG. 3). Registering with the organization allows the organization to uniquely identify each independent entity that will be raising funds and generating revenue on behalf of the organization. Once a non-member becomes a member, the member can set up a user profile at login page 300 and access the integrated financial instrument management system as shown in FIG. 3. During registration, the organization may deny the registration, for example, if all requested data has not been submitted or if the user is already an active member of the network. If the registration is denied, the registration process is re-initiated at Step 206 or the session is terminated. Although FIG. 2 shows Step 204 as enabling users to join a “fundraising network”, it is understood that if desired, the system can configured to implement architecture in which users may join a sales network, a donor network, a social network or any other symbiotic network that is built, maintained and/or nourished by an organization to generate revenue and good will among independent participants and third-party donors.

Upon successful registration with the integrated financial instrument management system, a user may download a financial contribution management application at Step 208. The financial contribution management application can facilitate user access to the integrated financial instrument management system, for instance, via a user interface such as log-in screen 300 shown in FIG. 3. The financial contribution management application may be distributed as a software tool configured for mobile applications that is downloaded to independent entities as part of contribution activity from third parties to the organization. The application can be implemented partly or entirely using a cloud service. Step 208 may include, for example, implementations in which a browser is used to access an application, a cloud application in which a user would login to the cloud application to interact with the application or combinations of local and remote software.

At Step 210, a user may initiate a campaign in the fundraising network. As used herein, a “campaign” may be a fundraising or sales campaign, a single revenue generating event, a short-term or long-term revenue generating goal or any complement or combination thereof. A campaign may be initiated by the organization and have goals to be fulfilled by independent participants. From the participant's perspective, a “campaign” will be set up by the participant in the network corresponding to the organization's campaign and having revenue generating goals in line with those established by the organization. For example, a non-profit organization establishes a one-time fitness event to raise a predetermined funding goal for patients affected by chronic and terminal illness. Participants take part in this campaign by agreeing to attend the fitness event and soliciting donations from third-party donors. Each participant initiates his/her own “campaign” by setting personal fundraising goals in line with the organization's predetermined overall goal.

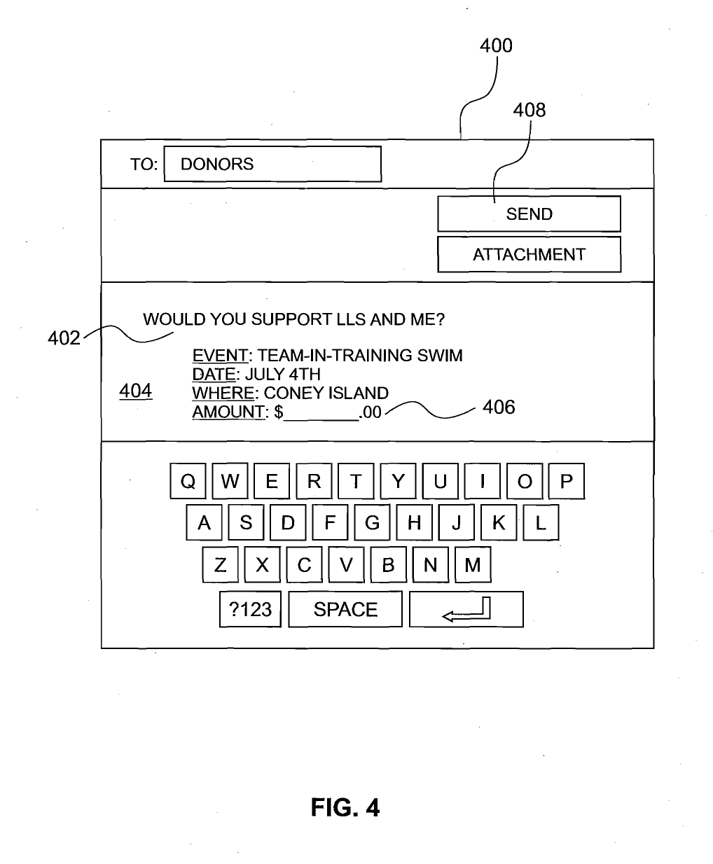

Participants send the fundraising solicitation to third-party donors at Step 212. Such solicitation may be transmitted via digital means to a network-connected client device such as mobile device 400 shown in FIG. 4. As used herein, the terms “mobile device”, “wireless mobile device” and “wireless device” may be used interchangeably, in the singular or plural, to refer to smartphones, PDAs, tablets, near-field communication devices, devices with applications implemented at least partly using a cloud service and any other complementary and equivalent devices.

FIG. 4 shows device 400 in receipt of a notification 402 from a participant who is soliciting donations in support of a campaign initiated in Step 210. Notification 402 may be a text, SMS message, e-mail or other message transmitted by electronic means and visible on a mobile device display 404. It is understood that the notification of the participant's solicitation may be a voice mail or other audible message, a tactile or vibratory notification or any other means for communicating participant's solicitation to donors and potential donors. Alternatively, the solicitation may be sent by postal mail, advertised by hard copy and electronic means or shared by word of mouth.

In the exemplary notification shown in FIG. 4, the participant solicits revenue for a one-time fundraising event on behalf of a non-profit organization (although other types of campaigns may be represented by participant on behalf of an organization). Donors may pledge a funding amount 406 in response to this solicitation (or agree to purchase certain goods and/or services in other exemplary embodiments), which funding amount (or purchase price) may be paid by cash, credit or charge card or by check or other financial instrument. The integrated financial instrument management system may optionally include an interface for a donor to elect payment by one of these payment methods, and this election may be transmitted as a notification to the participant and/or the organization. The integrated financial instrument management system thereby integrates payment by check to complement payments by cash and credit card. A donor who elects to pay by check can notify the participant that a check for funds in the designated amount is forthcoming. Alternatively, a donor may simply mail or hand deliver a check to the participant for eventual delivery by the participant to the organization.

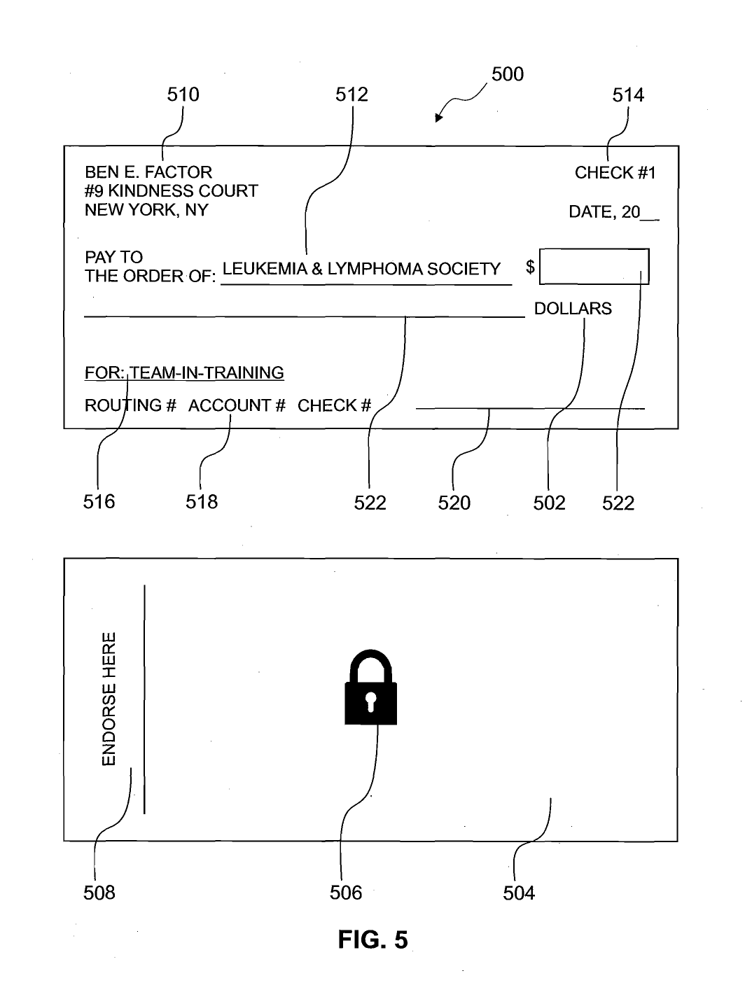

At Step 214, the user collects financial instruments from third-party donors, which instruments may include a check 500 as shown in FIG. 5. Check 500 has a front 502 that includes third-party donor data thereon and a back 504 that may include a security watermark 506 and an endorsement region 508. Third-party data provided on check front 502 may include, but is not limited to, a donor's identification information 510 as recognized by the paying bank (including but not limited to the donor's name, address and phone number), a payee name 512, a check number 514, a memo line 516, routing number and checking account information number 518, a signature line 520 and an indication 522 of the funds being transferred by the payor to the payee. As further described below, all or any portion of the third-party data may be collected by the integrated financial instrument management system and recorded for use by the organization's customer relationship management (CRM) system. Check 500 is an illustrative example of a financial instrument having capturable data incorporated therewith. Such financial instruments therefore are not limited to checks (e.g., cash may be amenable for capture of the serial numbers imprinted thereon).

At Step 216, a user logged into the integrated financial instrument management system captures an image of collected checks using a network-connected mobile device (such as device 400 shown in FIG. 4). The image includes a captured image of check front 502 having third party data visible thereon, although the captured image may also include an image of check back 504. The mobile device may be a Smartphone, tablet, PDA or complementary or equivalent mobile device having an image capturing means integral therewith. The image capturing means may be a camera or scanner integrated with the mobile device and establishing communication for delivery of captured images over a network. Alternatively, the user may use a digital camera with the ability to transmit images through a network, such as a cellular, Wi-Fi or equivalent network. If desired, in some embodiments, such as when the financial instrument is not made of paper or on physical media that is tangibly delivered to another, an electronic financial instrument (e.g., comprising a discrete structure representative of a physical check, one or a series of messages corresponding to a check, etc.) can be captured by the mobile device or other device of the participant, e.g., by using wireless or wired transmission through near communications between two devices such as within a few feet of each. If desired, a combination of different processes can be performed to collect necessary information such an image capture and RFID collection (e.g., electronic embedded or associated with the check).

At Step 218, the captured image is transmitted over the network to a payment processor for validation. The payment processor may be a processor or engine recognized under Check 21 banking regulations as being legally authorized to deposit and clear checking transactions. The payment processor may be one or more entities, such as an image capture entity and a banking entity (although the payment processor is not limited to such image capture and banking entities). In an embodiment, there is an automated feature that automatically sends the image upon capture or confirmation of capture by the user. For example, when the user selects to put the device/software in a “check capture” mode, taking the picture of the check, or taking the picture and confirming the picture automatically handles the transmission of the captured image to the payment processor). Confirmation and/or transmission of the captured image may be effected by selecting a “SEND” function provided in the integrated financial instrument management system, an exemplary embodiment of which is shown as a “SEND” icon or button 408 on mobile device 400 in FIG. 4 using existing network transmission means. The user who executes Steps 216 and 218 may be a participant who is collecting checks on behalf of the organization. In other exemplary embodiments, the user may be an organization receiving checks that are collected by a participant who then transfers the checks to the organization (e.g., by hand at a fundraising event, by mail, etc.).

At Step 220, the payment processor validates the captured image and the funding amount designated by the check and decides whether to present the check for deposit into the organization's account. Also, the payment processor may validate that the captured image is sufficiently legible to perform such cross-referencing function. If the payment processor is unable to validate the captured image, or if the payment processor is unable to determine the availability of sufficient funds designated by the check, the captured image is not validated and the captured image step is re-initiated at Step 216 or the session is terminated. The integrated financial instrument management system may send a notification to the user that validation was not successful. The notification may include a request for the user to either re-submit the captured image or to re-capture the image for subsequent transmission to and validation by the payment processor. If the payment processor validates the captured image and amount, the payment processor deposits the funding mount in the organization's account at Step 222. The integrated financial instrument management system may be configured to identify specific organization accounts into which certain deposits should be made. Participants will not have access to such account designation in the integrated financial instrument management system, thereby ensuring the security of all deposits and adequate cash flow for the organization.

Together, Steps 216, 218, 220 and 222 represent elements of an exemplary remote deposit capture process in that these steps enable the integrated financial instrument management system to deposit check-designated funds into a bank account from a remote location. This process eliminates the need to physically deliver the check to payee's bank and further eliminating the need for the payee's bank to then deliver the physical check to the payor's bank for presentation. This remote deposit capture process is acknowledged under Check 21 as a viable and legally acceptable means of effecting checking transactions (e.g., the payment processor may be a Check 21 payment processing vendor external to the organization). This process executed within the integrated financial instrument management system therefore employs existing network infrastructure to obviate inherent time lags experienced by organizations from submission of check-backed funds to receipt of such funds. For non-profit organizations, immediate benefits are realized when funds can be instantaneously accrued from checks without fear of bounced or lost checks. Such benefits may be particularly appreciated at events where participants hand over a large number of physical checks to an organization, and the events are remote from the organization's offices. At such events, checks are susceptible to loss and mishandling. In addition, the organization requires exceptional temporal and fiscal resources to organize the checks, transport the checks to the organization's offices, associate the funding amounts with the donors and participants, arrange for deposit of the checks into the organization's accounts and ensure proper recognition of donors for their donations and participants for their fundraising efforts. The incorporation of this process obviates these deficiencies.

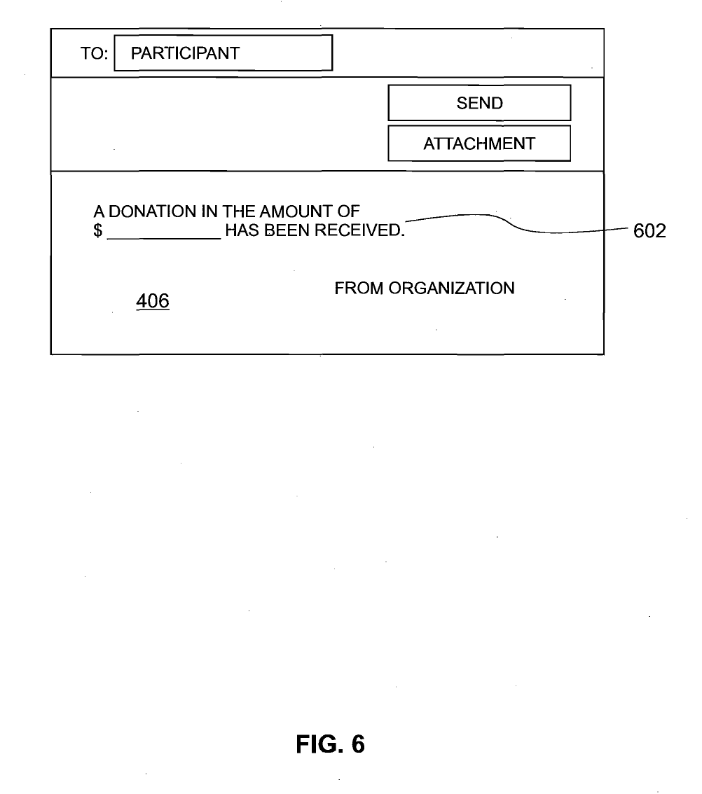

At Step 224, the integrated financial instrument management system alerts the user that a successful deposit of check-designated funds has been made into the organization's account. The alerting may comprise a notification such as a text, SMS or email message 602 delivered, for example, to a mobile device display 404 as shown in FIG. 6. Alternatively, the notification may comprise a voice message, tactile or vibratory communication or other effective means for communicating the availability of a successful deposit. If the user is a participant, the notification may include information associating the deposit to a particular campaign. If the user is an organization, the notification may include information associating the deposit to a particular campaign as well as information regarding the specific account into which the deposit was entered.

At Step 226, the integrated financial instrument management system records the deposit as a recognized monetary contribution raised by the participant and given by the donor to the organization. The deposit may be recorded in a database as the amount of funds from each image-captured check.

At Step 228, the integrated financial instrument management system adds the recognized monetary contribution to a fundraising total associated with the participant. The integrated financial instrument management system associates both the recognized monetary contribution and the fundraising total with the participant who generated the corresponding revenues. The fundraising total is updated with each recognized monetary contribution, and the updated fundraising total is associated with the participant.

Also at Step 228, the integrated financial instrument management system also records third-party donor data from the image-captured checks. This, for example, can be an automated process which uses text recognition or other automatic data collection feature to automatically collect data from financial instruments. A third-party data acquisition database may be provided that stores the third-party data acquired from the image-captured checks. The third-party acquisition database may be the same as the database in which deposits are recorded at Step 226 or may comprise one or more additional databases. The third-party data acquisition database may be provided in communication with an engine that is configured to associate amounts of funds from the image-captured checks with the third-party data. The engine may also be configured to record deposited funds as recognized monetary contributions associated with at least one of the participant and the donor. The engine may be further configured to provide an automated search and query capability for matching the third-party data to at least one of monetary contributions, recognized monetary contributions, a fundraising total and an updated fundraising total. This latter capability may be beneficial for integration of third-party data within an organization's CRM system for future business development activities.

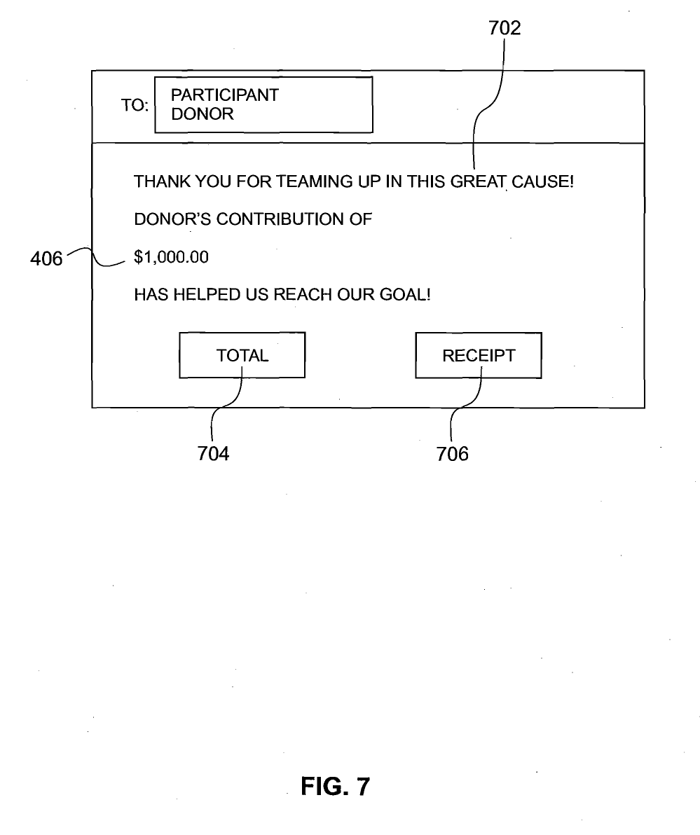

At Step 230, the integrated financial instrument management system recognizes at least one of the participant for collecting funds on behalf of the organization and the donor for generating funds on behalf of the organization. The recognizing may include notifying at least one of the participant and the donor of the recognized contribution, which notification may be a text, SMS or email message 702 displayed on a mobile device display as shown in FIG. 7 (although the notification may comprise any other format as described above and conducive to recognizing the monetary contribution made by the donor and generated by the participant). The recognizing may also include generating a notification that notifies the participant with updated fundraising or revenue totals. The updated totals may include an updated total from all donors for all activities in which the participant participates on behalf of the organization.

The integrated financial instrument management system may provide the participant with an optional interface to see such updated total, for instance, via an icon or “SEE YOUR TOTAL” button 310 as shown on log-in screen 300 in FIG. 3. The updated total may also include discrete totals attributable to single events or single donors (for instance, a total amount attributable to a single donor over many revenue-generating campaigns, or all funds raised from all donors for one campaign). The integrated financial instrument management system may provide the participant with an optional interface to see such updated totals, for instance, via an icon or “TOTAL” button 704 as shown on mobile device display 404 in FIG. 7. In an exemplary embodiment, generation of the notification is based upon matches between a participant's fundraising total and at least one of target monetary contributions and target fundraising totals. For instance, if the organization set a goal for the participant to raise $1,000.00 and the participant meets or surpasses that goal, the organization may credit the participant accordingly (for example, with an award or a gift). The financial contribution management application may be configured to automatically update and display cumulative totals of contributions from image-captured checks and financial instruments in response to capturing a new image.

The integrated financial instrument management system may also permit donors to see updated totals for campaigns into which the donors have paid funds to the organization via collection from the participant. The notification includes at least one of a current fundraising total, an acknowledgment of appreciation and a receipt for the recognized monetary contribution. For example, the integrated financial instrument management system may automatically generate a tax receipt for a donor to a non-profit organization, which the system may deliver to the donor via electronic means. The donor may be able to access the automatically generated tax receipt via the platform, for instance by accessing the network interface by an icon or “RECEIPT” button 706 as shown on a mobile device display 404 as shown in FIG. 7. The integrated financial instrument management system can also provide the option to have a hard copy of the receipt delivered to the donor's physical address. It is understood that such a function is also amenable to issuance of receipts by for-profit organizations for purchases of goods and/or services, which receipts may be immediately relied upon by third-party entities to ensure accurate accounting of expenditures.

The integrated financial instrument management system may also support an application for participants to acquire “points” or “credits” for participation in revenue generation events and also for supporting other participants' endeavors in driving revenue generation activities, including enlistment of new participants and collection of funds from new donors. Accumulation of “credits” can encourage philanthropic and collaborative behavior of the participants and donors in the non-profit and for-profit communities. The notification may include a message advising the participant of the credit, which can encourage the participant to expand revenue generating efforts. The integrated financial instrument management system may credit at least one of the participant and the donor to an extent commensurate with at least one of the recognized monetary contribution and the associated fundraising total.

The process 200 ends at Step 232 when a user logs off of the integrated financial instrument management system or when a revenue generating campaign is terminated. The user may re-start process 200 at any time prior to logging out.

Systems and methods illustratively described herein may be particularly beneficial in the field of charitable fundraising. Systems and methods illustratively described herein may also provide particular advantages when implemented with mobile devices. It is understood that any steps, logical functions or features disclosed herein may be implemented in a variety of combinations (for example, by omitting on or more step(s) and/or function(s) or implementing one or more step(s) in different sequences).

The disclosed integrated financial instrument management solution employs the benefits of network-based banking infrastructure to realize the immediacy of deposit and processing methodology. For the multi-level marketing industry, organizations that employ the disclosed integrated financial instrument management solution obviate waste in fulfilling orders incorrectly. Additionally, both for-profit and non-profit organizations gain considerable improvements in customer experience from staff members who no longer bear responsibility for orders and donations paid for with funds from insufficiently funded checking accounts.

In the non-profit charitable giving space, all actors realize significant advantages in the exchange of financial instruments. Donors are accorded timely and accurate recognition of third-party giving and provided with immediately generated receipts for tax and accounting purposes. Participants receive timely, accurate and inspiring recognition for fundraising and revenue generating efforts, thereby visualizing the instant impact that the revenue imparts. This translates into greater potential for fundraising efforts as well as positive reinforcement to enlist others as participants and donors. These operations can be performed by the system such as by a user device (e.g., data is collected from checks in real time, as the checks are received and captured corresponding information is updated, such as by implementing instantaneous recordation and transmission of receipts for checks (by the a mobile device) when each check is captured, updating contribution totals in real time or instantaneously, and check images are instantly sent to a check processor (e.g., with or without being routed to the organizations routers or application complex that handles the fund raising operation or applications)). Organizations realize significant reductions in wasteful annual bank deposit efforts, manual efforts in revenue recognition and manual efforts to tabulate fundraising results. With upfront capture of donor information at the point of mobile deposit, participants can more easily identify their third-party donors, thereby allowing organizations a greater capacity to cultivate relationships while recognizing each and every entity involved in fundraising efforts. This is all accomplished in a manner that considerably reduces the time and resources expended by all actors by providing an easily accessible platform. This may all be accomplished by one or more of a method, system and/or apparatus for integrated financial instrument management and may be executed by instructions included on a computer-readable medium.

For the sake of brevity, it should be understood that certain structures and functionality, or aspects thereof, of embodiments of the presently disclosed invention that are evident from the illustrations of the figures have not been necessarily restated herein.

It is to be understood that the presently disclosed invention is not to be limited to the exact configurations as illustrated and described herein. To those of ordinary skill in the art, one or more inventions will be understood to be contemplated from the present application. Accordingly, all expedient modifications readily attainable by one of ordinary skill in the art from the disclosure set forth herein, or by routine experimentation there from, are deemed to be within the spirit and scope of the invention as defined by the appended claims.

What is claimed is:

1. A method for operating an automated programmed computer system that associates an independent entity that collects financial instruments on behalf of an organization with funds collected on behalf of the organization, comprising:
capturing an image of each financial instrument collected from a plurality of third party entities using a financial contribution management application in operative communication with an image capture component of a network-connected client device, wherein each financial instrument identifies an amount of funds, the organization as a payee, and a contributing third party entity;
sending the captured image of each financial instrument to a destination to apply the captured image to a payment processor for the organization to deposit and clear the instrument for the organization;
generating a communications message notifying the independent entity of a successful deposit of funds from one or more financial instruments in response to sending the captured images;
in response to sending the captured image, recording in a database each amount of funds from a plurality of the image-captured financial instruments as a recognized monetary contribution raised by the independent entity and given by the third-party entity to the organization;
adding the recognized monetary contribution to a fundraising total associated with the independent entity; and
providing the independent entity with an option to view the fundraising total from third party entities for the organization.

2. The method of claim 1 wherein the network-connected client device effects at least one of the image capturing and sending.

3. The method of claim 2 wherein the financial contribution management application provides the independent entity with the option to view the fundraising total.

4. The method of claim 1 further comprising recognizing at least one of the independent entity for collecting funds on behalf of the organization and the third-party entity for generating funds on behalf of the organization.

5. The method of claim 4 wherein the recognizing includes generating a notification that notifies the independent entity with updated fundraising totals and credits at least one of the independent entity and the third-party entity to an extent commensurate with at least one of the recognized monetary contribution and the associated fundraising total.

6. The method of claim 5, wherein generation of the notification is based upon matches between an independent entity's fundraising total and at least one of target monetary contributions and target fundraising totals.

7. The method of claim 5, wherein the notification includes at least one of a current fundraising total, an acknowledgment of appreciation and a receipt for the recognized monetary contribution.

8. The method of claim 1, wherein the recording includes recording each deposited amount of funds from the financial instrument as a recognized monetary contribution raised by the independent entity and given by the third party.

9. The method of claim 1 further including recording third-party data acquired from the captured image into a database associated with the organization.

10. The method of claim 9 further including providing a platform comprising:
a network interface for performing at least one of:
communicating over a network;
facilitating registration of the independent entity with the organization; and
accessing the platform by the registered independent entity;
a third-party data acquisition database that stores third-party data acquired from the captured image; and
an engine configured to:
associate amounts of funds from financial instruments with the third-party data;
record deposited funds as recognized monetary contributions associated with at least one of the independent entity and third-party entity;
update the fundraising total; and
associate the updated fundraising total with the independent entity.

11. The method of claim 10 further including registering the independent entity with the organization, wherein the registering allows the organization to uniquely identify each independent entity that will be fundraising on behalf of the organization.

12. The method of claim 10, wherein the engine is further configured to provide an automated search and query capability for matching third-party data to at least one of monetary contributions, recognized monetary contributions, the fundraising total and the updated fundraising total.

13. The method of claim 10, wherein the engine is further configured to generate a notification that notifies the independent entity with updated fundraising totals and credits at least one of the independent entity and the third-party entity to an extent commensurate with at least one of the recognized monetary contribution and the associated fundraising total.

14. The method of claim 13, wherein the notification includes at least one of a current fundraising total, an acknowledgment of appreciation and a receipt for the recognized monetary contribution.

15. The method of claim 1, further comprising distributing the financial contribution management applications as a software tool configured for mobile applications that is downloaded to independent entities as part of contribution activity from third parties to the organization.

16. The method of claim 1, further comprising distributing the financial contribution management application, wherein the application is configured to automatically update and display cumulative totals of contributions from image-captured financial instruments in response to capturing a new image.

17. The method of claim 1, further comprising automatically sending the captured image to the payment processor.

18. An integrated financial instrument management system for associating an independent entity that collects financial instruments on behalf of an organization with funds collected on behalf of the organization, comprising:
a server in communication with a search engine and at least one network-connected client device having an image capture component in operative communication with a financial contribution management application, the server configured to perform actions comprising:
accessing the system over a network; and
performing the method of claim 1.

19. The system of claim 18, wherein the at least one network-connected client device effects at least one of image capturing and sending of each financial instrument.

20. The system of claim 18, wherein the financial contribution management application provides the independent entity with the option to view a fundraising total.

21. The system of claim 18 wherein the actions to be performed further comprise: recognizing at least one of the independent entity for collecting funds on behalf of the organization and the third-party entity for generating funds on behalf of the organization.

22. The system of claim 21, wherein the recognizing includes generating a notification that notifies the independent entity with updated fundraising totals and credits at least one of the independent entity and the third-party entity to an extent commensurate with at least one of the recognized monetary contribution and the associated fundraising total.

23. The system of claim 22, wherein generation of the notification is based upon matches between an independent entity's fundraising total and at least one of target monetary contributions and target fundraising totals.

24. The system of claim 22, wherein the notification includes at least one of a current fundraising total, an acknowledgment of appreciation and a receipt for the recognized monetary contribution.

25. The system of claim 18, wherein the system records each deposited amount of funds from each financial instrument as a recognized monetary contribution raised by the independent entity and given by the third party.

26. The system of claim 18, wherein the actions to be performed further comprise:
recording third-party data acquired from a captured image of each financial instrument collected from third party entities into a database associated with the organization.

27. The system of claim 18 further including:
a platform comprising:
a network interface for performing at least one of communicating over a network, facilitating registration of the independent entity with the organization and accessing the platform by the registered independent entity;
a third-party data acquisition database that stores third-party data acquired from the captured image; and
an engine configured to:
associate amounts of funds from financial instruments with the third-party data;
record deposited funds as recognized monetary contributions associated with at least one of the independent entity and third-party entity;
update the fundraising total; and
associate the updated fundraising total with the independent entity.

28. The system of claim 27 wherein registration allows the organization to uniquely identify each independent entity that will be fundraising on behalf of the organization.

29. The system of claim 27, wherein the engine is further configured to provide an automated search and query capability for matching third-party data to at least one of monetary contributions, recognized monetary contributions, the fundraising total and the updated fundraising total.

30. The system of claim 27, wherein the engine is further configured to generate a notification that notifies the independent entity with updated fundraising totals and credits at least one of the independent entity and the third-party entity to an extent commensurate with at least one of the recognized monetary contribution and the associated fundraising total.

31. The system of claim 30, wherein the notification includes at least one of a current fundraising total, an acknowledgment of appreciation and a receipt for the recognized monetary contribution.

32. The system of claim 18, wherein the actions to be performed further comprise:
distributing the financial contribution management application as a software tool configured for mobile applications that is downloaded to independent entities as part of contribution activity from third parties to the organization.

33. The system of claim 18, wherein the actions to be performed further comprise:
distributing the financial contribution management application, wherein the application is configured to automatically update and display cumulative totals of contributions from image-captured financial instruments in response to capturing a new image.

34. The system of claim 18, wherein the actions to be performed further comprise:
automatically transmitting at least one captured image over the network to a payment processor for validation.

35. An apparatus for associating an independent entity that collects financial instruments on behalf of an organization with funds collected on behalf of the organization, comprising:
a network interface for communicating over a network; and
a computer-readable medium configured to perform actions that comprise:
accessing an integrated financial instrument management system over the network;
capturing an image of each financial instrument collected from a plurality of third party entities using a financial contribution management application in operative communication with an image capture component of a network-connected client device, wherein each financial instrument identifies an amount of funds, the organization as a payee, and a contributing third party entity;
sending the captured image of each financial instrument to a destination to apply the captured image to a payment processor for the organization to deposit and clear the instrument for the organization;
in response to sending the captured image, recording in a database each amount of funds from the image-captured financial instruments as a recognized monetary contribution raised by the independent entity and given by the third-party entity to the organization;
uploading third-party data acquired from the captured image to the integrated financial instrument management system for storage on the database;
generating a communications message notifying the independent entity of a successful deposit of funds from one or more financial instruments in response to sending the captured images;
adding the recognized monetary contribution to a fundraising total associated with the independent entity; and
providing the independent entity with an option to view the fundraising total from third party entities for the organization.

36. A method of operation of an apparatus for associating an independent entity that collects financial instruments on behalf of an organization with funds collected on behalf of the organization, the method comprising using the apparatus to:
communicate over a network; and
perform actions that comprise:
accessing an integrated financial instrument management system over the network;
capturing an image of each financial instrument collected from a plurality of third party entities using a financial contribution management application in operative communication with an image capture component of a network-connected client device, wherein each financial instrument identifies an amount of funds, the organization as a payee, and a contributing third party entity;
sending the captured image of each financial instrument to a destination to apply the captured image to a payment processor for the organization to deposit and clear the instrument for the organization;
in response to sending the captured image, recording in a database each amount of funds from the image-captured financial instruments as a recognized monetary contribution raised by the independent entity and given by the third-party entity to the organization;
uploading third-party data acquired from the captured image to the integrated financial instrument management system for storage on the database;
generating a communications message notifying the independent entity of a successful deposit of funds from one or more financial instruments in response to sending the captured images;
adding the recognized monetary contribution to a fundraising total associated with the independent entity; and
providing the independent entity with an option to view the fundraising total from third party entities for the organization.
